(19) United States
(12) Patent Application Publication
(10) Pub. No.: US 2026/0134213 A1
(43) Pub. Date: May 14, 2026

(54) Training method and apparatus for large models

(71) Applicant: Alipay (Hangzhou) Information Technology Co., Ltd., Hangzhou (CN)

(72) Inventors: Furong XU, Hangzhou (CN); Qingpei GUO, Hangzhou (CN); Ming YANG, Hangzhou (CN)

(21) Appl. No.: 19/009,733

(22) Filed: Jan. 3, 2025

(30) Foreign Application Priority Data
Jan. 4, 2024 (CN) 202410010377.9

(51) Int. Cl. G06F 40/279

(52) U.S. Cl. CPC G06F 40/279

(57) ABSTRACT

Embodiments of this specification provide a training method and apparatus for large models. The large model includes a first quantity of first network layers with a same first structure. The method includes: performing preliminary training on the large model under a first constraint condition, where the first constraint condition imposes a limitation that in the preliminary training process, different first network layers use same parameters; and when the limitation imposed by the first constraint condition is removed, performing further training on the large model obtained after the preliminary training. Therefore, fast convergence of the model can be ensured.

### TECHNICAL FIELD

One or more embodiments of this specification relate to the computer field, and in particular, to a training method and apparatus for large models.

### BACKGROUND

In the field of artificial intelligence, a large model refers to a model with a large quantity of parameters, for example, a deep neural network with more than 1 billion parameters, which can process a huge amount of data, complete various complex tasks, such as natural language processing, computer vision, and speech recognition. With continuous improvement of computer hardware performance and continuous optimization of a deep learning algorithm, development of the large model is also becoming increasingly rapid. A parameter scale of the large model continuously expands, training time becomes increasingly long, and performance improves accordingly. Nowadays, the large model has become one of important research directions in the artificial intelligence field. Many enterprises and institutions are developing their own large models to achieve better performance in various tasks.

In an existing technology, a large amount of sample data can be collected to train one's own large model, where the sample data may relate to privacy data of a user, and the privacy data needs to be protected from leakage. In addition, when the large model is trained, an excessively large quantity of parameters often causes the model to fail to converge.

### SUMMARY

One or more embodiments of this specification describe a training method and apparatus for large models, which can ensure fast convergence of the model.

According to a first aspect, a training method for large models is provided. A large model includes a first quantity of first network layers with a same first structure, and the method includes:
performing preliminary training on the large model under a first constraint condition, where the first constraint condition imposes a limitation that in a preliminary training process, different first network layers use same parameters; and
when the limitation imposed by the first constraint condition is removed, performing further training on the large model obtained after the preliminary training.

In a possible implementation, the first structure includes a first network part and a second network part; the further training includes a first sub-training with a second constraint condition and a second sub-training in which the second constraint condition is removed, where the first sub-training and the second sub-training are successively performed; and the second constraint condition imposes a limitation that first network parts of different first network layers use same parameters in a sub-training process.

Further, the large model is specifically a multimodal large model applicable to a picture mode and a text mode, the first network part includes a self-attention sublayer, and the second network part includes a first feed-forward neural network sublayer corresponding to the picture mode and a second feed-forward neural network sublayer corresponding to the text mode.

In a possible implementation, the large model further includes a second quantity of second network layers with a same second structure; and the first constraint condition imposes a further limitation that in the preliminary training process, different second network layers use same parameters.

Further, the second structure includes a third network part and a fourth network part; the further training includes a first sub-training with a second constraint condition and a second sub-training in which the second constraint condition is removed, where the first sub-training and the second sub-training are successively performed; and the second constraint condition imposes a limitation that third network parts of different second network layers use same parameters in a sub-training process.

Further, the first structure includes a first network part and a second network part; and the second constraint condition imposes a further limitation that first network parts of different first network layers use same parameters in a sub-training process.

Further, the large model is specifically a multimodal large model applicable to a picture mode and a text mode, the first network part includes a self-attention sublayer, and the second network part includes a first feed-forward neural network sublayer corresponding to the picture mode and a second feed-forward neural network sublayer corresponding to the text mode; the third network part is a self-attention sublayer shared by two modes; and the fourth network part includes a third feed-forward neural network sublayer shared by the two modes.

In a possible implementation, the large model is a multimodal large model applicable to a picture mode and a text mode, an input of the large model includes a first initial vector of the picture mode and a second initial vector of the text mode, and an output of the large model includes a first fusion vector of the picture mode and a second fusion vector of the text mode; the first initial vector includes a picture embedding vector of a sample picture and block embedding vectors respectively corresponding to a plurality of image blocks in the sample picture, and the second initial vector includes a sentence embedding vector of a sample sentence and word embedding vectors respectively corresponding to a plurality of segments in the sample sentence; and the first fusion vector includes a picture fusion vector of the sample picture and block fusion vectors respectively corresponding to the plurality of image blocks, and the second fusion vector includes a sentence fusion vector of the sample sentence and word fusion vectors respectively corresponding to the plurality of segments.

Further, the preliminary training and/or the further training include/includes the following training manner: adjusting a model parameter by maximizing a score of similarity between a sample picture and a sample sentence included in a positive sample pair and minimizing a score of similarity between a sample picture and a sample sentence included in a negative sample pair, where a similarity score is determined based on vector similarity between a picture fusion vector of the sample picture and a sentence fusion vector of the sample sentence.

Further, the preliminary training and/or the further training include/includes the following training manner: randomly masking block embedding vectors corresponding to a part of image blocks in the first initial vector, or randomly masking word embedding vectors corresponding to a part of segments in the second initial vector, predicting a masked image block or segment through an output of the large model, and adjusting a model parameter based on a predicted masked object and an actual masked object.

According to a second aspect, a training apparatus for large models is provided. A large model includes a first quantity of first network layers with a same first structure, and the apparatus includes:
a first training unit, configured to perform preliminary training on the large model under a first constraint condition, where the first constraint condition imposes a limitation that in a preliminary training process, different first network layers use same parameters; and
a second training unit, configured to: when the limitation imposed by the first constraint condition is removed, perform further training on the large model obtained after the preliminary training by the first training unit.

According to a third aspect, a computer-readable storage medium that stores a computer program is provided, and when the computer program is executed on a computer, the computer is caused to perform the method according to the first aspect.

According to a fourth aspect, a computing device is provided, including a memory and a processor. The memory stores executable code, and when the processor executes the executable code, the method according to the first aspect is implemented.

According to the method and the apparatus provided in embodiments of this specification, for a structure feature that a large model includes the first quantity of first network layers with a same first structure, the following training manner is used: First, preliminary training is performed on the large model under the first constraint condition, where the first constraint condition imposes a limitation that in a preliminary training process, different first network layers use same parameters; and then, when the limitation imposed by the first constraint condition is removed, further training is performed on the large model obtained after the preliminary training. It can be seen from the above-mentioned description that, in the embodiments of this specification, in the preliminary training process, different first network layers use same parameters, so that a quantity of to-be-adjusted parameters in model training is greatly decreased relative to an original parameter quantity. Subsequently, in the further training process, the quantity of to-be-adjusted parameters is gradually decreased, so that fast convergence of the model can be ensured.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following descriptions show merely some embodiments of this specification, and a person of ordinary skill in the art can still derive other drawings from these accompanying drawings without creative efforts.

FIG. 1 is a schematic diagram illustrating an implementation scenario, according to an embodiment of this specification;

FIG. 2 is a schematic diagram illustrating an implementation scenario, according to another embodiment of this specification;

FIG. 3 is a schematic diagram illustrating an implementation scenario, according to another embodiment of this specification;

FIG. 4 is a flowchart illustrating a training method for large models, according to an embodiment; and

FIG. 5 is a schematic block diagram illustrating a training apparatus for large models, according to an embodiment.

### DESCRIPTION OF EMBODIMENTS

The solutions provided in this specification are described below with reference to the accompanying drawings.

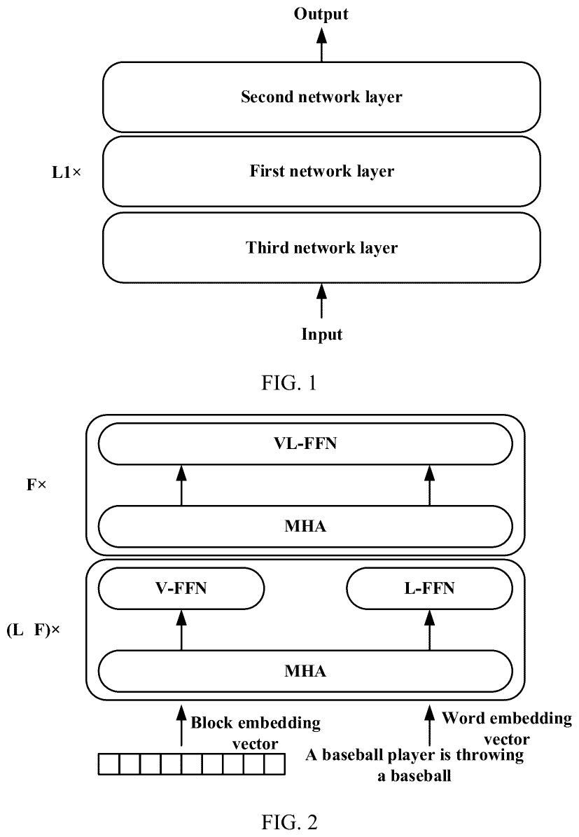

FIG. 1 is a schematic diagram illustrating an implementation scenario, according to an embodiment of this specification. This implementation scenario relates to training of a large model. The large model includes a first quantity of first network layers with a same first structure. It can be understood that different first network layers have a same structure, that is, the large model has a repeated structure. Referring to FIG. 1, in this embodiment of this specification, the large model has a repeated structure, and the repeated structure forms a main component part of the large model. Optionally, the large model can further include another component part in addition to the above-mentioned repeated structure. For example, the large model in FIG. 1 includes L1 first network layers, and the L1 first network layers belong to the repeated structure. In addition, a second network layer and a third network layer are further included, and the second network layer and the third network layer are optional component parts. FIG. 1 shows a possible composition structure of the large model. Unlike the case shown in FIG. 1, the large model can include only the L1 first network layers, or include only the L1 first network layers and the second network layer, or include only the L1 first network layers and the third network layer.

It should be noted that, when the large model further includes the second network layer and/or the third network layer, a quantity of second network layers and/or third network layers is not specifically limited. In other words, the large model can include only one second network layer, or can include a plurality of second network layers with a same structure. Similarly, the large model can include only one third network layer, or can include a plurality of third network layers with a same structure. A plurality of second network layers with a same structure or third network layers with a same structure form a repeated structure. In this embodiment of this specification, the large model can include only one group of repeated structures, or can include a plurality of groups of repeated structures.

In this embodiment of this specification, the large model has a large quantity of parameters, and can have a quantity of 10 billion parameters. If pre-training parameter initialization is not performed and training starts from scratch, the model often fails to converge during training.

Generally, the large model is trained in a layer-by-layer training manner. For a large model with L layers in total, a first layer is first trained and fixed; then a second layer is trained, and the first layer and the second layer are fixed; and a third layer is trained, until an L^{th} layer. There is a relatively large quantity of training steps, and fast convergence cannot be achieved.

To resolve the above-mentioned problem, in this embodiment of this specification, based on a structural feature of the large model, preliminary training is performed on the model by using same parameters for different first network layers, so that a quantity of to-be-adjusted parameters in model training is greatly decreased relative to an original parameter quantity. Subsequently, in a further training process, the quantity of the to-be-adjusted parameters is gradually increased, so that fast convergence of the model can be ensured.

FIG. 2 is a schematic diagram illustrating an implementation scenario, according to another embodiment of this specification. In this implementation scenario, a large model is specifically a multimodal large model. The multimodal large model is a model that has a huge quantity of parameters and whose input includes a plurality of modes, such as a picture mode, a text mode, an audio mode, and a video mode. In this embodiment of this specification, an input of the multimodal large model includes the picture mode and the text mode, for example, block embedding vectors respectively corresponding to a plurality of image blocks included in a sample picture and word embedding vectors respectively corresponding to a plurality of segments included in a sample sentence. The sample sentence is “A baseball player is throwing a baseball”. The sample picture is a picture that is consistent with content of the sample sentence, and content in the picture, expressed through colors, lines, etc., is consistent with text. A model structure relates to a self-attention (multi-head self-attention, MHA) sublayer and a feed-forward neural network (FFN) sublayer. Referring to FIG. 2, the model structure includes a total of L layers, where the first (L-F) layers are (L-F) first network layers, and the last F layers are F second network layers. The first network layer has a first structure, the first structure includes a first network part and a second network part, the first network part is a self-attention sublayer MHA shared by two modes, and the second network part includes a first feed-forward neural network sublayer V-FFN corresponding to the picture mode and a second feed-forward neural network sublayer L-FFN corresponding to the text mode. The second network layer has a second structure, the second structure includes a third network part and a fourth network part, the third network part is a self-attention sublayer MHA shared by two modes, and the fourth network part includes a third feed-forward neural network sublayer VL-FFN shared by two modes.

There are a total of L layers in the model. MHA parts of the first (L-F) layers are shared by different modes, FFN parts of the first (L-F) layers are exclusively used by different modes, both MHA parts and FFN parts of the last F layers are shared by different modes. Structural stacking enables fusion between different modes at different layers. Parameters of different modes are shared as much as possible to enhance a capability of fusing different modes by the model, thereby improving a multimodal representation capability.

In this embodiment of this specification, the large model can be a large model developed by an enterprise and an organization, and has a large quantity of parameters, for example, a quantity of 10 billion parameters. For example, the large model is specifically a multimodal large model. A quantity of model parameters can be increased by increasing a depth and a width, thereby improving a capability of representing multimodal content by the mode. An increase in the depth is an increase in a quantity of layers, and an increase in the width can be an increase in a quantity of feature dimensions of input data, or an increase in a quantity of heads of multi-head attention at the MHA sublayer, etc.

It can be understood that both the first network layer and the second network layer in FIG. 2 belong to a repeated structure. In this embodiment of this specification, in an optional solution, same parameters can be first used for different first network layers and same parameter are used for different second network layers to perform preliminary training on the model, so that a quantity of to-be-adjusted parameters in model training is greatly decreased relative to the original parameter quantity.. Subsequently, in a further training process, the quantity of to-be-adjusted parameters is gradually increased, thereby ensuring fast convergence of the model. In another optional solution, if (L-F) is far greater than F, that is, the first network layer is a primary component part of the large model and the second network layer is a secondary component part of the large model, and therefore a quantity of parameters of the second network layer can be ignored. Same parameters are only used for different first network layers to perform preliminary training on the model, so that a quantity of to-be-adjusted parameters in model training is greatly decreased relative to an original parameter quantity. Subsequently, in a further training process, the quantity of to-be-adjusted parameters is gradually increased, thereby ensuring fast convergence of the model.

It should be noted that the model structure of the multimodal large model shown in FIG. 2 is only a possible model structure. In this embodiment of this specification, when the multimodal large model is trained, the structure of the multimodal large model can be flexible and diverse, provided that the multimodal large model includes a first quantity of first network layers with a same first structure. A specific structure of the first network layer is not limited to the model structure shown in FIG. 2. For example, the first network layer has a first structure, and the first structure includes a first network part and a second network part. The first network part includes a first self-attention sublayer V-MHA corresponding to the picture mode and a second self-attention sublayer L-MHA corresponding to the text mode. The second network part includes a first feed-forward neural network sublayer V-FFN corresponding to the picture mode and a second feed-forward neural network sublayer L-FFN corresponding to the text mode.

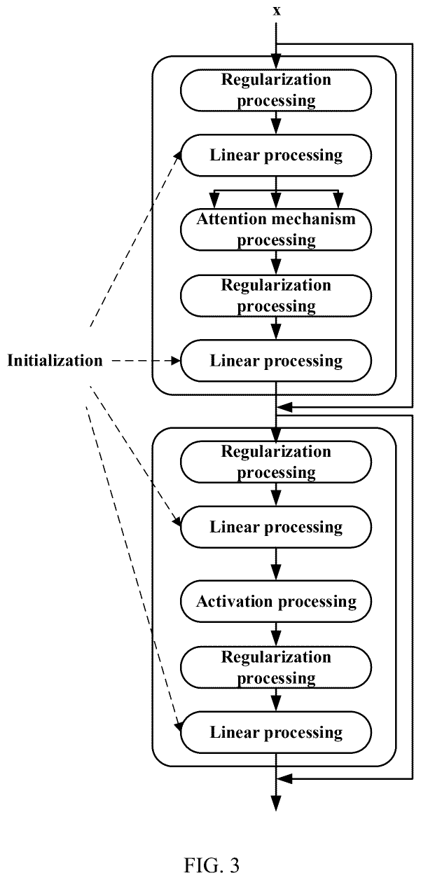

FIG. 3 is a schematic diagram illustrating an implementation scenario, according to another embodiment of this specification. A large model is specifically the multimodal large model shown in FIG. 2. A model structure relates to an MHA sublayer and an FFN sublayer. FIG. 3 shows a possible structure of the MHA sublayer and the FFN sublayer. Referring to FIG. 3, the MHA sublayer sequentially performs regularization processing, linear processing, attention mechanism processing, regularization processing, and linear processing on an input x of the MHA sublayer. An output of the MHA sublayer is used as an input of the FFN sublayer, and the FFN sublayer sequentially performs regularization processing, linear processing, activation processing, regularization processing, and linear processing on the input of the FFN sublayer. The normalization processing performs a normalization or standardization operation. The normalization refers to mapping an input to 0-1, for example, dividing a pixel value of a color picture by 255 to normalize the pixel value to 0-1. The standardization refers to processing input data, so that input data has a Gaussian distribution with a mean of 0 and a variance of 1. For example, LN is a common standardization operation. The linear processing, which can be implemented by using a Linear function, relates to a large quantity of parameters. The parameters can be initialized before model training. In the attention mechanism processing, an attention mechanism usually is referred to as an Attention mechanism. In the deep learning field, a model usually needs to receive and process a large amount of data. However, at a specific moment, only a small part of data is important. In this case, it is very suitable to use the Attention mechanism. In the activation processing, for example, ReLU is used as an activation function, and ReLu may cause outputs of some neurons to be 0.As a result, network sparsity is caused, a mutual dependence relationship between parameters is reduced, and occurrence of an over-fitting problem is alleviated.

It can be seen from FIG. 3 that, there is also a repeated structure at the MHA sublayer and the FFN sublayer. For example, the regularization processing and the linear processing repeatedly occurs at the MHA sublayer, and the regularization processing and the linear processing repeatedly occurs at the FFN sublayer.

In this embodiment of this specification, preliminary training is performed on the model by using same parameters for different processing units with a same structure, so that a quantity of a to-be-adjusted parameter in model training is greatly decreased relative to an original parameter quantity. Subsequently, in a further training process, the quantity of the to-be-adjusted parameter is gradually increased, so that fast convergence of the model can be ensured. The processing unit can refer to a network layer of the model, a sublayer obtained by further dividing the network layer, or a processing structure obtained by further dividing the sublayer, etc. In addition, different processing units with a same structure can be two adjacent processing units, for example, two adjacent first network layers in FIG. 1; or can be two non-adjacent processing units, for example, any two MHA sublayers in the first (L-F) layers in FIG. 2, or two regularization processing structures at the MHA sublayers in FIG. 3.

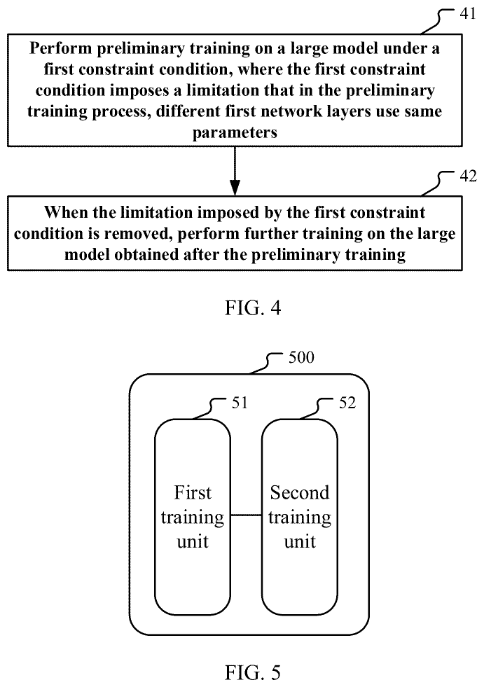

FIG. 4 is a flowchart illustrating a training method for large models, according to an embodiment. The large model includes a first quantity of first network layers with a same first structure. The method can be based on the implementation scenario shown in FIG. 1, FIG. 2, or FIG. 3. As shown in FIG. 4, the training method for large models in this embodiment includes the following steps: Step 41: Perform preliminary training on the large model under a first constraint condition, where the first constraint condition imposes a limitation that in the preliminary training process, different first network layers use same parameters. Step 42: When the limitation imposed by the first constraint condition is removed, perform further training on the large model obtained after the preliminary training. Specific manners for performing the above-mentioned steps are described below.

First, in step 41, preliminary training is performed on the large model under the first constraint condition, where the first constraint condition imposes a limitation that in the preliminary training process, different first network layers use same parameters. It can be understood that, different first network layers use same parameters, so that a total quantity of parameters of the first quantity of first network layers can be decreased to a quantity of parameters of one first network layer.

In this embodiment of this specification, the large model can include only the first quantity of first network layers, or can include not only the first quantity of first network layers, but also another network layer. For example, in FIG. 1, the large model includes not only the first quantity of first network layers, but also a second network layer and/or a third network layer. The large model can have only one second network layer, or can have a plurality of second network layers with a same structure. Similarly, the large model can have only one third network layer, or can have a plurality of third network layers with a same structure.

In an example, the large model further includes a second quantity of second network layers with a same second structure; and the first constraint condition imposes a further limitation that in the preliminary training process, different second network layers use same parameters.

In this example, different second network layers use same parameters, so that a total quantity of parameters of the second quantity of second network layers can be decreased to a quantity of parameters of one second network layer, thereby further decreasing a total quantity of parameters of the entire large model.

Then, in step 42, when the limitation imposed by the first constraint condition is removed, further training is performed on the large model obtained after the preliminary training. It can be understood that, the limitation imposed by the first constraint condition is removed, that is, different first network layers can use different parameters, so that a quantity of parameters in the model in the further training process is increased relative to that in the preliminary training process.

In this embodiment of this specification, in the further training process, all parameters can be completely released for further training without using any constraint condition. Alternatively, the further training is divided into a plurality of sub-trainings that are successively performed. Different constraint conditions are used in all sub-training and no constraint condition is used in last sub-training, so that some parameters at different first network layers in sub-training with the constraint condition are the same. Compared with that in sub-training that is performed first, a smaller quantity of parameters are the same at different first network layers in sub-training. Parameters are gradually released for training, and all parameters can be released for training in last performed sub-training.

In an example, the first structure includes a first network part and a second network part; the further training includes a first sub-training with a second constraint condition and a second sub-training in which the second constraint condition is removed, where the first sub-training and the second sub-training are successively performed; and the second constraint condition imposes a limitation that first network parts of different first network layers use same parameters in a sub-training process.

Further, the large model is specifically a multimodal large model applicable to a picture mode and a text mode, the first network part includes a self-attention sublayer, and the second network part includes a first feed-forward neural network sublayer corresponding to the picture mode and a second feed-forward neural network sublayer corresponding to the text mode.

The first network part can include a self-attention sublayer shared by two modes, or the first network part can include a first self-attention sublayer corresponding to the picture mode and a second self-attention sublayer corresponding to the text mode.

For example, the first (L-F) layers of the model in FIG. 2 is the first quantity of first network layers, the first network part is a self-attention sublayer MHA, and the second network part includes a first feed-forward neural network sublayer V-FFN and a second feed-forward neural network sublayer L-FFN.

In an example, the large model further includes a second quantity of second network layers with a same second structure; and the first constraint condition imposes a further limitation that in the preliminary training process, different second network layers use same parameters. Further, the second structure includes a third network part and a fourth network part; the further training includes a first sub-training with a second constraint condition and a second sub-training in which the second constraint condition is removed, where the first sub-training and the second sub-training are successively performed; and the second constraint condition imposes a limitation that third network parts of different second network layers use same parameters in a sub-training process.

In this example, the large model includes the first quantity of first network layers with a same first structure, and further includes the second quantity of second network layers with a same second structure. In the preliminary training process, different first network layers use same parameters, and different second network layers also use same parameters. In the further training process, a parameter limitation on the first network layer can be completely released, and parameters at the second network layer are gradually released for training in a plurality of times of training that are successively performed.

Further, the first structure includes a first network part and a second network part; and the second constraint condition imposes a further limitation that first network parts of different first network layers use same parameters in a sub-training process.

In this example, the large model includes the first quantity of first network layers with a same first structure, and further includes the second quantity of second network layers with a same second structure. In the preliminary training process, different first network layers use same parameters, and different second network layers also use same parameters. In the further training process, parameters at the first network layer and the second network layer are gradually released for training in a plurality of times of training that are successively performed.

Further, the large model is specifically a multimodal large model applicable to a picture mode and a text mode, the first network part includes a self-attention sublayer, and the second network part includes a first feed-forward neural network sublayer corresponding to the picture mode and a second feed-forward neural network sublayer corresponding to the text mode; the third network part is a self-attention sublayer shared by two modes; and the fourth network part includes a third feed-forward neural network sublayer shared by two modes.

The first network part can include a self-attention sublayer shared by two modes, or the first network part can include a first self-attention sublayer corresponding to the picture mode and a second self-attention sublayer corresponding to the text mode.

For example, the first (L-F) layers of the model in FIG. 2 is the first quantity of first network layers, the first network part is a self-attention sublayer MHA, and the second network part includes a first feed-forward neural network sublayer V-FFN and a second feed-forward neural network sublayer L-FFN. The last F layers of the model in FIG. 2 are the second quantity of second network layers, the third network part is a self-attention sublayer MHA, and the fourth network part includes a third feed-forward neural network sublayer VL-FFN.

In an example, the large model is a multimodal large model applicable to a picture mode and a text mode, an input of the large model includes a first initial vector of the picture mode and a second initial vector of the text mode, and an output of the large model includes a first fusion vector of the picture mode and a second fusion vector of the text mode; the first initial vector includes a picture embedding vector of a sample picture and block embedding vectors respectively corresponding to a plurality of image blocks in the sample picture, and the second initial vector includes a sentence embedding vector of a sample sentence and word embedding vectors respectively corresponding to a plurality of segments in the sample sentence; and the first fusion vector includes a picture fusion vector of the sample picture and block fusion vectors respectively corresponding to the plurality of image blocks, and the second fusion vector includes a sentence fusion vector of the sample sentence and word fusion vectors respectively corresponding to the plurality of segments.

In this example, one picture is divided into a plurality of image blocks. For example, one picture is divided into nine image blocks with an equal size in a manner of separately dividing the picture in a horizontal direction and a vertical direction. Segment processing is performed on the sample sentence, and a single segment can include one or more words.

Further, the preliminary training and/or the further training include/includes the following training manner: adjusting a model parameter by maximizing a score of similarity between a sample picture and a sample sentence included in a positive sample pair and minimizing a score of similarity between a sample picture and a sample sentence included in a negative sample pair, where the similarity score is determined based on vector similarity between a picture fusion vector of the sample picture and a sentence fusion vector of the sample sentence.

In this example, the large model is trained by using a contrastive loss task, which helps the large model achieve a good retrieval effect when being subsequently used to retrieve a task.

Further, the preliminary training and/or the further training include/includes the following training manner: randomly masking block embedding vectors corresponding to some image blocks in the first initial vector, or randomly masking word embedding vectors corresponding to some segments in the second initial vector, predicting a masked image block or segment through an output of the model, and adjusting a model parameter based on a predicted masked object and an actual masked object.

In this example, the large model is trained by using a mask training task, which can combine the mask training task with a contrastive loss task. In a first phase, the mask training task is used to train the large model, and in a second phase, the contrastive loss task is further used to train the large model. This helps the large model achieve a good effect when subsequently being used for tasks that mainly require an understanding ability, for example, a generation task.

In this embodiment of this specification, a convergence problem exists when a model with a large quantity of parameters is directly trained from scratch, and parameters are gradually released for training to enable fast convergence of a multimodal large model. Using the multimodal large model shown in FIG. 2 as an example, the following three-step training method can be used:
Step 1: Perform inter-layer parameter sharing, where different layers use same parameters, so that a total quantity of parameters is approximately equal to an original parameter quantity N: N/L, and the training is performed until convergence is achieved.
Step 2: Perform MHA sublayer parameter sharing, where MHA sublayers at different layers use same parameters, and parameters are gradually released for training until convergence is achieved.
Step 3: Release all parameters for training until convergence is achieved.

It should be noted that the above-mentioned three-step training method is an optional training process. In practice, a manner of gradually releasing parameters for training can specifically include two steps, three steps, four steps, etc. A quantity of steps required for completing training can be selected with reference to a specific model structure.

According to the method provided in this embodiment of this specification, for a structure feature that the large model includes the first quantity of first network layers with a same first structure, the following training manner is used: First, preliminary training is performed on the large model under the first constraint condition, where the first constraint condition imposes a limitation that in the preliminary training process, different first network layers use same parameters; and then, when the limitation imposed by the first constraint condition is removed, further training is performed on the large model obtained after the preliminary training. It can be seen from the above-mentioned description that, in the embodiments of this specification, in the preliminary training process, different first network layers use same parameters, so that a quantity of to-be-adjusted parameters in model training is greatly decreased relative to an original parameter quantity. Subsequently, in the further training process, the quantity of to-be-adjusted parameters is gradually decreased, so that fast convergence of the model can be ensured.

According to an embodiment in another aspect, a training apparatus for large models is further provided. A large model includes a first quantity of first network layers with a same first structure, and the apparatus is configured to perform the method provided in the embodiments of this specification. FIG. 5 is a schematic block diagram illustrating a training apparatus for large models, according to an embodiment. As shown in FIG. 5, the apparatus 500 includes:
a first training unit 51, configured to perform preliminary training on the large model under a first constraint condition, where the first constraint condition imposes a limitation that in a preliminary training process, different first network layers use same parameters; and
a second training unit 52, configured to: when the limitation imposed by the first constraint condition is removed, perform further training on the large model obtained after the preliminary training by the first training unit 51.

Optionally, in an embodiment, the first structure includes a first network part and a second network part; the further training includes a first sub-training with a second constraint condition and a second sub-training in which the second constraint condition is removed, where the first sub-training and the second sub-training are successively performed; and the second constraint condition imposes a limitation that first network parts of different first network layers use same parameters in a sub-training process.

Further, the large model is specifically a multimodal large model applicable to a picture mode and a text mode, the first network part includes a self-attention sublayer, and the second network part includes a first feed-forward neural network sublayer corresponding to the picture mode and a second feed-forward neural network sublayer corresponding to the text mode.

Optionally, in an embodiment, the large model further includes a second quantity of second network layers with a same second structure; and the first constraint condition imposes a further limitation that in the preliminary training process, different second network layers use same parameters.

Further, the second structure includes a third network part and a fourth network part; the further training includes a first sub-training with a second constraint condition and a second sub-training in which the second constraint condition is removed, where the first sub-training and the second sub-training are successively performed; and the second constraint condition imposes a limitation that third network parts of different second network layers use same parameters in a sub-training process.

Further, the first structure includes a first network part and a second network part; and the second constraint condition imposes a further limitation that first network parts of different first network layers use same parameters in a sub-training process.

Further, the large model is specifically a multimodal large model applicable to a picture mode and a text mode, the first network part includes a self-attention sublayer, and the second network part includes a first feed-forward neural network sublayer corresponding to the picture mode and a second feed-forward neural network sublayer corresponding to the text mode; the third network part is a self-attention sublayer shared by two modes; and the fourth network part includes a third feed-forward neural network sublayer shared by the two modes.

Optionally, in an embodiment, the large model is a multimodal large model applicable to a picture mode and a text mode, an input of the large model includes a first initial vector of the picture mode and a second initial vector of the text mode, and an output of the large model includes a first fusion vector of the picture mode and a second fusion vector of the text mode; the first initial vector includes a picture embedding vector of a sample picture and block embedding vectors respectively corresponding to a plurality of image blocks in the sample picture, and the second initial vector includes a sentence embedding vector of a sample sentence and word embedding vectors respectively corresponding to a plurality of segments in the sample sentence; and the first fusion vector includes a picture fusion vector of the sample picture and block fusion vectors respectively corresponding to the plurality of image blocks, and the second fusion vector includes a sentence fusion vector of the sample sentence and word fusion vectors respectively corresponding to the plurality of segments.

Further, the preliminary training and/or the further training include/includes the following training manner: adjusting a model parameter by maximizing a score of similarity between a sample picture and a sample sentence included in a positive sample pair and minimizing a score of similarity between a sample picture and a sample sentence included in a negative sample pair, where a similarity score is determined based on vector similarity between a picture fusion vector of the sample picture and a sentence fusion vector of the sample sentence.

Further, the preliminary training and/or the further training include/includes the following training manner: randomly masking block embedding vectors corresponding to a part of image blocks in the first initial vector, or randomly masking word embedding vectors corresponding to a part of segments in the second initial vector, predicting a masked image block or segment through an output of the large model, and adjusting a model parameter based on a predicted masked object and an actual masked object.

According to the apparatus provided in this embodiment of this specification, for a structure feature that the large model includes the first quantity of first network layers with a same first structure, the following training manner is used: First, the first training unit 51 performs preliminary training on the large model under the first constraint condition, where the first constraint condition imposes a limitation that in the preliminary training process, different first network layers use same parameters. Then, when the limitation imposed by the first constraint condition is removed, the second training unit 52 performs further training on the large model obtained after the preliminary training. It can be seen from the above-mentioned description that, in the embodiments of this specification, in the preliminary training process, different first network layers use same parameters, so that a quantity of to-be-adjusted parameters in model training is greatly decreased relative to an original parameter quantity. Subsequently, in the further training process, the quantity of to-be-adjusted parameters is gradually decreased, so that fast convergence of the model can be ensured.

According to an embodiment in another aspect, a computer-readable storage medium is further provided. The computer-readable storage medium stores a computer program, and when the computer program is executed in a computer, the computer is enabled to perform the method described with reference to FIG. 4.

According to an embodiment in still another aspect, a computing device is further provided, including a memory and a processor. The memory stores executable code, and when the processor executes the executable code, the method described with reference to FIG. 4 is implemented.

A person skilled in the art may recognize that in one or more of the above-mentioned examples, the functions described in this specification can be implemented by hardware, software, firmware, or any combination thereof. When implemented by software, the functions can be stored in a computer-readable medium or transmitted as one or more instructions or code on a computer-readable medium.

The objectives, technical solutions, and benefits of this specification are further described in detail in the specific implementations described above. It should be understood that the above-mentioned descriptions are merely specific implementations of this specification, but are not intended to limit the protection scope of this specification. Any modification, equivalent replacement, or improvement made based on the technical solutions of this specification shall fall within the protection scope of this specification.

1. A training method for large models, wherein a large model comprises a first quantity of first network layers with a same first structure, and the method comprises:
performing preliminary training on the large model under a first constraint condition, wherein the first constraint condition imposes a limitation that in a preliminary training process, different first network layers use same parameters; and
when the limitation imposed by the first constraint condition is removed, performing further training on the large model obtained after the preliminary training.

2. The method according to claim 1, wherein the first structure comprises a first network part and a second network part; the further training comprises a first sub-training with a second constraint condition and a second sub-training in which the second constraint condition is removed, wherein the first sub-training and the second sub-training are successively performed; and the second constraint condition imposes a limitation that first network parts of different first network layers use same parameters in a sub-training process.

3. The method according to claim 2, wherein the large model is specifically a multimodal large model applicable to a picture mode and a text mode, the first network part comprises a self-attention sublayer, and the second network part comprises a first feed-forward neural network sublayer corresponding to the picture mode and a second feed-forward neural network sublayer corresponding to the text mode.

4. The method according to claim 1, wherein the large model further comprises a second quantity of second network layers with a same second structure; and the first constraint condition imposes a further limitation that in the preliminary training process, different second network layers use same parameters.

5. The method according to claim 4, wherein the second structure comprises a third network part and a fourth network part; the further training comprises a first sub-training with a second constraint condition and a second sub-training in which the second constraint condition is removed, wherein first sub-training and the second sub-training are successively performed;
and the second constraint condition imposes a limitation that third network parts of different second network layers use same parameters in a sub-training process.

6. The method according to claim 5, wherein the first structure comprises a first network part and a second network part; and the second constraint condition imposes a further limitation that first network parts of different first network layers use same parameters in a sub-training process.

7. The method according to claim 6, wherein the large model is specifically a multimodal large model applicable to a picture mode and a text mode, the first network part comprises a self-attention sublayer, and the second network part comprises a first feed-forward neural network sublayer corresponding to the picture mode and a second feed-forward neural network sublayer corresponding to the text mode; the third network part is a self-attention sublayer shared by two modes; and the fourth network part comprises a third feed-forward neural network sublayer shared by the two modes.

8. The method according to claim 1, wherein the large model is a multimodal large model applicable to a picture mode and a text mode, an input of the large model comprises a first initial vector of the picture mode and a second initial vector of the text mode, and an output of the large model comprises a first fusion vector of the picture mode and a second fusion vector of the text mode; the first initial vector comprises a picture embedding vector of a sample picture and block embedding vectors respectively corresponding to a plurality of image blocks in the sample picture, and the second initial vector comprises a sentence embedding vector of a sample sentence and word embedding vectors respectively corresponding to a plurality of segments in the sample sentence; and the first fusion vector comprises a picture fusion vector of the sample picture and block fusion vectors respectively corresponding to the plurality of image blocks, and the second fusion vector comprises a sentence fusion vector of the sample sentence and word fusion vectors respectively corresponding to the plurality of segments.

9. The method according to claim 8, wherein the preliminary training and/or the further training comprise/comprises the following training manner: adjusting a model parameter by maximizing a score of similarity between a sample picture and a sample sentence comprised in a positive sample pair and minimizing a score of similarity between a sample picture and a sample sentence comprised in a negative sample pair, wherein a similarity score is determined based on vector similarity between a picture fusion vector of the sample picture and a sentence fusion vector of the sample sentence.

10. The method according to claim 8, wherein the preliminary training and/or the further training comprise/comprises the following training manner: randomly masking block embedding vectors corresponding to a part of image blocks in the first initial vector, or randomly masking word embedding vectors corresponding to a part of segments in the second initial vector, predicting a masked image block or segment through an output of the large model, and adjusting a model parameter based on a predicted masked object and an actual masked object.

11. A training apparatus for large models, wherein a large model comprises a first quantity of first network layers with a same first structure, and the apparatus comprises:
a first training unit, configured to perform preliminary training on the large model under a first constraint condition, wherein the first constraint condition imposes a limitation that in a preliminary training process, different first network layers use same parameters; and
a second training unit, configured to: when the limitation imposed by the first constraint condition is removed, perform further training on the large model obtained after the preliminary training by the first training unit.

12. A computer-readable storage medium, wherein the computer-readable storage medium stores a computer program, and when the computer program is executed on a computer, the computer is enabled to perform the method according to any one of claims 1 to 10.

13. A computing device, comprising a memory and a processor, wherein the memory stores executable code, and when the processor executes the executable code, the method according to any one of claims 1 to 10 is implemented.
